(19) United States
(12) Patent Application Publication
(10) Pub. No.: US 2004/0126550 A1
(43) Pub. Date: Jul. 1, 2004

(54) Panel and process for producing a panel

(76) Inventor: Thomas Grafenauer, Onzour sur Loire (FR)

Correspondence Address: McGuireWoods LLP, Suite 1800, 1750 Tysons Boulevard, Tysons Corner, McLean, VA, 22102-4215, US

(21) Appl. No.: 10/697,560

(22) Filed: Oct. 31, 2003

(30) Foreign Application Priority Data
Nov. 12, 2002 (DE) 102 52 866.7

(51) Int. Cl. B32B 7/02

(52) U.S. Cl. 428/212

(57) ABSTRACT

The present invention relates to a panel, in particular floor panel, having a support board (1) made of glued and compressed fiber material to which a termination layer (10) is applied in each case on a top side (15) and an underside (5), and the termination layer (10) of the top side (15) has a structured surface, and to a process for producing such a panel or such a support board. The object of the invention is to provide a panel or a support board (1) comprising binders and fillers and also a process for producing the same, by means of which surface-structured panels can be produced more quickly and cost-effectively. This object is achieved in that the density on the top side (15) of the support board (1) is lower than the density of the support board (1) on the underside (5).

The invention relates to a panel according to the preamble of claim 1 and to a process for producing a panel according to the preamble of claim 11. A support board for a panel and a process for producing such a support board also form part of the subject matter of the invention.

Such a panel or such a support board is suitable, in particular, for a floor panel.

The support boards used in laminate flooring are usually HDF or MDF boards which have a stamped formation on the surface in order for it to be possible to achieve a decoration-following structure on the top side. The stamping process is carried out in parallel with a short-cycle coating operation, while a plurality of paper layers are pressed with one another and with a mat made of woodbased material, preferably fibers. The structure here is produced by pressing plates which have a negative structure. This process is expensive and is distinguished by pressing plates being subjected to high levels of wear.

The object of the invention is to provide a panel or a support board made of binders and fillers, and also a process for producing the same, by means of which surface-structured panels can be produced more quickly and cost-effectively.

This object is achieved according to the invention by a panel having the features of claim 1 and a support board and a process for producing the same according to claims 11 [sic] and 15, respectively. Advantageous configurations and developments of the invention are described in the subclaims.

The fact that the density on the top side of the support board differs from that on the underside facilitates the operation of stamping or structuring the support board on account of the lower strength, as a result of which the wear to which the stamping plates or other structuring tools are subjected is reduced. It is likewise possible for the structuring or stamping to take place more quickly, which overall results in quicker and more cost-effective production.

Designing the support board with a density of less than 700 kg/m³, while at the same time having a gluing factor of greater than 10%, results in the support board having more or less plastic-like properties in respect of weight and strength, although the amount of material used, on account of the embedded woodbased materials, preferably fibers, is considerably lower.

A development provides that the support board has a density of between 400 kg/m³ and 650 kg/m³, this resulting in optimum strength in relation to the density and the amount of material used.

Urea-formaldehyde resins (UF resins) or melamin [sic]-enhanced urea-formaldehyde resins (MUF) are advantageously used for gluing the woodbased materials or fibers of the support board. It is also possible to use isocyanates as the means for gluing the fibers [sic] in the support board, the invention providing isocyanates with gluing factors of less than 20%. On account of their high heat resistance, isocyanates also make it possible to realize higher gluing factors. It is likewise the case that the addition of isocyanates maintains the strength during heat-intensive coating of the support board since, if use is made exclusively of urea-formaldehyde resins, there is a tendency for the support board to undergo a loss in strength during coating.

For appropriate production of support boards, depending on loading and use purpose, it is provided that a mixture of isocyanates and UF or MUF resins is used as the means for gluing the woodbased materials or fibers and the support board.

A development of the invention provides that the support board has a non-uniform density distribution over the cross section from the top side to the underside, the cover layer located on the underside having a density in the region of 1000 kg/m³, whereas the central layers in the cross section are compressed to 400 kg/m³−600 kg/m³. The top side has a lower density than the underside, but advantageously a greater density than in the center of the support board. The higher levels of compression on the top side and underside ensures a high resistance against vertical mechanical loading, as is necessary, for example, when used for floor panels. A panel with such a support board is provided on the top side and the underside in each case with a termination layer, which usually comprises a melamin [sic]-impregnated decorative layer or counteracting layer, in order additionally to protect the support board against mechanical damage.

On account of the reduction in weight of the support boards of comparatively low relative density, the transportation costs are lowered and, furthermore, the support board achieves a hitherto unknown level of flexibility, which allows for specific profile configurations, in particular in the case of so-called click-in connections.

Furthermore, the increase in the gluing factor results in improved moisture resistance since the reduced proportion of woodbased materials in the boards reduces the inclination of the support board to swell up. The penetration of wetness into the region where two support boards or two floor panels are connected results in the support boards swelling up in this region and thus in the floor being destroyed. On account of the lesser tendency to swell up (below 5%), the support board according to the invention and a floor panel produced thereby are suitable, in particular, for use in wet rooms.

In addition, the layers of different densities within the support board result in a refraction of the sound waves at the density-transition locations, so that the footfall and room sound is markedly reduced.

The process for producing a panel, in particular a floor panel, in the case of which a support board is produced by the compression and heating of glued woodbased materials makes provision for the support board to be provided with a structured surface on a top side, and for a termination layer to be applied to the support board provided with the stamped formation. Setting different densities on the top side and the underside of the support board facilitates the stamping of the support board because the strength of the cover layer of the support board is lower on the top side than on the underside. The overall strength of the panel is only adversely affected to a slight extent since the underside has a very high density and strength and improved material values can be achieved on account of the high gluing proportions.

The single-sided reduction in the bulk density of the support board on the top side during the production process takes place either by virtue of the cover layer of the top side being ground off or by the single-sided application of good heat conductors, such as water, on the underside prior to the woodbased material being heated and compressed during the production of the support board. The supply of the heat-conducting media, for example by spraying the woodbased materials designed, for example as a fiber mat, results in the heat penetrating more quickly into the fiber mat. The adhesives are thus activated more quickly and enhanced compression takes place on one side of the fiber mat. On the opposite side, the degree of compression is correspondingly lower, with the result that this side can be used for easier surface stamping. This process maintains the fiber structure while, at the same time, having different densities on the top side and underside, which has an advantageous effect on the strength of the support board and of the panel.

As an alternative, or in addition, to the stamping operation, the structure of the support board may be produced by a grinding-off operation.

The invention is explained in more detail hereinbelow with reference to the attached figures, in which:

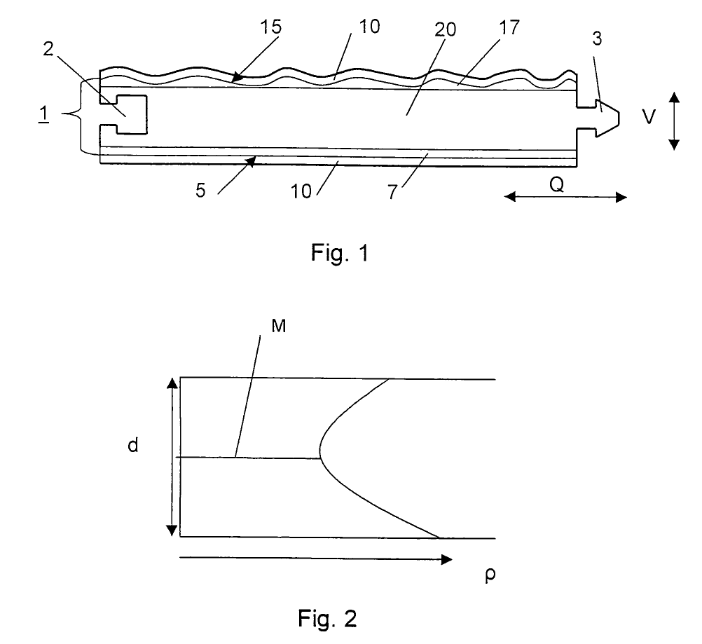

FIG. 1 shows a cross-sectional view of a panel; and

FIG. 2 shows a density distribution over the cross section of a support board.

FIG. 1 shows a cross section of a floor panel having a support board 1 with a termination layer 10 applied in each case to its top side 15 and underside 5. The termination layers 10 are applied, preferably glued, to the cover layers 7, 17, forming the outer termination of the support board 1, and protect the support board 1, for example, against moisture and mechanical loading. It is likewise possible for these termination layers 10 to have a decoration and to increase the mechanical stability of the floor panel.

Locking means 2, 3 are formed on the side edges of the panel, these locking means preventing two interconnected panels from moving relative to one another both in the vertical direction V and in the transverse direction Q. The support board 1 here is produced from a fiber material which is usually used for producing HDF boards; as an alternative, or in addition, other woodbased materials are incorporated. The cover layers 7, 17 of the support board 1 have a considerably higher density than the core 20 of the support board 1, densities of up to 1000 kg/m³ being achieved in the cover layers 7 of the underside 5, while lower densities are set in the cover layer 17 of the top side 15. Within the core 20, the density decreases continuously toward the center M of the support board 1, a corresponding density distribution over the thickness d of a support board 1 being illustrated in FIG. 2. The latter shows that the lowest value for the density ρ is achieved in the center M of the support board, while the density ρ increases over the thickness d of the support board, starting from the center M, in order to reach its maximum on the surfaces of the cover layers 7, 17, the maximum value on the top side 15 being lower than the maximum value on the underside 5.

The extremely high density, in the region of 1000 kg/m³, in the cover layer 7 of the underside 5 provides the support board 1 with the necessary resistance to vertical, mechanical loading, it being possible, in conjunction with the use of UF or MUF resins, if appropriate mixed with isocyanates, to produce a particular level of flexibility within the board. The addition of isocyanates improves the moisture resistance of the support board 1, with the result that the significant properties of the support board 1 are defined by the resins used and/or the plastics introduced.

FIG. 1, furthermore, shows the structured surface of the top side 15 and of the termination layer 10 applied thereto, it being possible for the structure to be provided by a stamping operation during coating with the termination layer 10. Since the density of the cover layer 17 on the top side 15 is lower than that on the underside 5, the stamping operation is rendered easier and the wear to which the stamping plates are subjected is reduced.

As an alternative to spraying the fiber mat with water, it is also possible for other heat-conducting media to be introduced specifically into the fibers, or applied to the fibers, in order to achieve an asymmetrical density distribution over the thickness of the support board. Liquids other than water may be used. It is likewise possible for an appropriate distribution of the woodbased materials or fibers to result in the mat which is to be pressed being such that the support board has an asymmetrical density distribution, for example by the top cover layer consisting of [sic] a material which cannot be compressed to such a high extent.

1. Panel, in particular floor panel, having a support board (1) made of glued and compressed fiber material to which a termination layer (10) is applied in each case on a top side (15) and an underside (5), and the termination layer (10) of the top side (15) has a structured surface, characterized in that the density on the top side (15) of the support board (1) is lower than the density of the support board (1) on the underside (5).

2. Panel according to claim 1, characterized in that the support board (1) has a density of less than 700 kg/m³.

3. Panel according to claim 1 or 2, characterized in that the gluing factor of the support board (1) is greater than 10%.

4. Panel according to one of the preceding claims, characterized by UF resins or MUF resins as the means for gluing the fibers of the support board (1).

5. Panel according to one of the preceding claims, characterized by isocyanates as the means for gluing the woodbased materials of the support board (1).

6. Panel according to claim 5, characterized by a gluing factor of less than 20% for isocyanates.

7. Panel according to one of the preceding claims, characterized by a mixture of isocyanates and UF or MUF resins as the means for gluing the woodbased materials of the support board (1).

8. Panel according to one of the preceding claims, characterized in that the support board (1) has a non-uniform density distribution over the cross section from the top side (15) to the underside (5).

9. Panel according to claim 8, characterized in that a density of 1000 kg/m³ is present on the underside (5) of the support board (1), while a density of from 400 kg/m³ to 600 kg/m³ is present in the center of the support board (1).

10. Support board (1) according to one of the preceding claims.

11. Process for producing a panel, in particular floor panel, in the case of which a support board (1) is produced by the compression and heating of glued woodbased materials, and the support board (1) is provided with a structured surface on a top side (15), and a termination layer (10) is applied to the support board (1) provided with the stamped formation, characterized in that the density on the top side (15) of the support board (1) is set to be lower than the density of the support board (1) on the underside (5).

12. Process according to claim 11, characterized in that the different densities are set by virtue of a cover layer of the top side (15) being ground off.

13. Process according to claim 11, characterized in that the different densities are set by the single-sided application of heat-conducting media, in particular water, to the underside (5) prior to the woodbased material being heated.

14. Process according to one of claims 11 to 13, characterized in that the structured surface is produced by a grinding-off and/or stamping operation.

15. Process for producing a support board (1) made of glued and compressed woodbased fiber material for a panel, in particular floor panel, in the case of which the density on the top side (15) of the support board (1) is lower than the density of the support board (1) on the underside (5), and in the case of which the fiber material is compressed with the supply of pressure and heat, characterized in that the density on the top side (15) of the support board (1) is set to be lower than the density of the support board (1) on the underside (5) by the single-sided application of water to the underside (5) prior to the woodbased material being heated and compressed.
